(19) United States
(12) Patent Application Publication
(10) Pub. No.: US 2008/0246322 A1
(43) Pub. Date: Oct. 9, 2008

(54) Seat for Vehicles

(75) Inventor: Peter Opsvik, Oslo (NO)

Correspondence Address: CHRISTIAN D. ABEL, ONSAGERS AS, POSTBOKS 6963 ST. OLAVS PLASS, NORWAY, N-0130, NO

(73) Assignee: PETER OPSVIK AS, Oslo (NO)

(21) Appl. No.: 12/092,580

(22) PCT Filed: Oct. 27, 2006
(86) PCT No.: PCT/NO06/00380

§ 371 Date: May 5, 2008

(30) Foreign Application Priority Data
Nov. 8, 2005 (NO) 20055244

(51) Int. Cl. B60N 2/18; B60N 2/22

(52) U.S. Cl. 297/354.12

(57) ABSTRACT

A seat for vehicles, such as cars, buses, trains or planes, is provided with a backrest (2) which is movable about a horizontal transversal axis (5) relative to the seat back plane. The backrest (2) is pivotably attached to a horizontal axis (5) mounted on an upwardly directed supporting part (4). One or more support surfaces (9) may also be provided in the seat part (3), at least in the front part. These are pivotably attached in a horizontal axis (8)

The invention relates to a seat for vehicles such as cars, buses, trains and planes, where the backrest and seat are movable over horizontal axes.

Whenever possible the human body always prefers movement to being static. In a standing position there is no one who chooses to stand completely still.

When sitting in a vehicle, for example in a car or other means of transport, one often has to sit still for long periods due to the fact that there is little possibility for movement. The need therefore arises for good support for the back and preferably also for the thighs at different sitting angles. In order to avoid becoming stiff by remaining in the same position, the person sitting in the seat will often wish to move and change position and it will therefore be desirable for the seat to encourage the possibility of movement and variation of the sitting position, while at the same time maintaining a good support for the back and thighs at the different sitting angles.

A number of proposals are known for designing the car seats so as to provide a better sitting position. Most of these known designs are based on an adjustment of the seat and back parts by operating various levers or wheels in order to alter the angles of the sitting position, but this requires a conscious action on the part of the user for regulating the angles of the seat by means of levers or by pressing buttons.

The object of the present invention is therefore to develop a seat, particularly for vehicles, which is simple in design and which permits the entire backrest of the seat and preferably also the front half of the seat part to tilt freely and follow the movements of the user, thus offering him the possibility of more movement and maximum support at different angles both for his back and thighs.

This object is achieved by a seat which is characterised by what will be apparent in the patent claims.

When a person is in a sitting position, the pelvis will generally be located in the same place while the upper body and thighs and legs require variation.

The whole backrest from seat to and including neck support is a unit that tilts about the axis at lower back level according to the user's wishes regarding angle of rest, and this is carried out freely and naturally without the user having to perform any adjustment operations. When the neck support tilts together with the rest of the backrest, the distance between head and neck rest will generally be the same at all angles of rest. Alternatively, if it is designed as an “active” neck support (i.e. it either moves or is inflated in the event of a collision), the neck support may be separated from the backrest, while during inflation or movement, the function of the neck support is adapted to the backrest's position.

The special feature of the seat according to the invention is that the entire back rest right to the top of the neck support is preferably pivotably attached to a horizontal axis mounted on a separate supporting part for the seat back. Since the entire backrest is pivotable, the user will be able to move forwards and backwards on the seat, whereby the entire backrest and the support surface for the neck follow suit, providing good support for the back portion at different sitting angles.

With regard to a tilting motion or pivoting motion for the backrest surface, it should of course be understood that this involves a limited movement, so that the whole seat back is not rotated.

In order to achieve such a pivoting motion for the seat's backrest, the seat may be provided with a supporting part in the form of an upwardly directed guide part or pillar, which is attached to the seat or the base of the seat, where the backrest is pivotably attached to this upward guide. The upward guide may be concealed inside the back structure or by a rear wall of the seat back.

The backrest may have a thickness of only a few cm except at the upward guide, thereby providing plenty of room for the backseat passenger's knees. Today's car seats have wide lateral edges on their backrests.

The seat's back part may be extended upwards to such a height that its upper part acts as a neck support. This means that the distance from head to rear support surface at all sitting angles remains the same, in contrast to solutions where only the lower part of the backrest is tiltable and the neck support has the same position. An ideal distance to the neck support is important for the user's safety, with regard to the risk of whiplash injury, for example.

According to a further feature of the invention, which may also be employed separately, the seat is provided with tiltable or pivotable parts in the seat portion. The seat's front support portions will thereby be tiltable about an axis in the front half of the seat, a tiltable plate being provided in this seat area.

This plate may be divided in the longitudinal direction in order to provide support during different angular positions of the thighs, while the seat cover may preferably be whole.

The underside of the right thigh (the accelerator pedal leg) in particular lacks support in car seats. This means that the front edge of the seat should be over 5 to 10 cm higher in order to provide relief for the right thigh. If the front edge of the seat is constantly at this height, getting in and out of the car will be difficult. It will therefore be advantageous to have a device whereby the front edge of the seat can be raised after the user has taken his seat in the car.

This raising function may be associated with the ignition lock, so that the seat is raised only when the engine starts, or when the car is placed in gear. Alternatively, the front edge of the seat may be lowered when the car door is unlocked or opened. Only when the support under the thigh has reached the right height does the invention work so that the height of the front edge of the seat adjusts itself in relation to the angle of the thigh. If one draws up one's leg, the pressure in front of the tilting point will be reduced and the pressure behind the tilting point will increase, with the result that the front edge rises, and vice versa if the leg/thigh is stretched out. For the right foot this will mean in practice that the front edge of the seat is adjusted automatically if the seat is moved forward or back. The left foot can change position as often as it wants and the plate tilts along with it.

The invention will now be explained in greater detail by means of embodiments, which are illustrated in the drawings, in which:

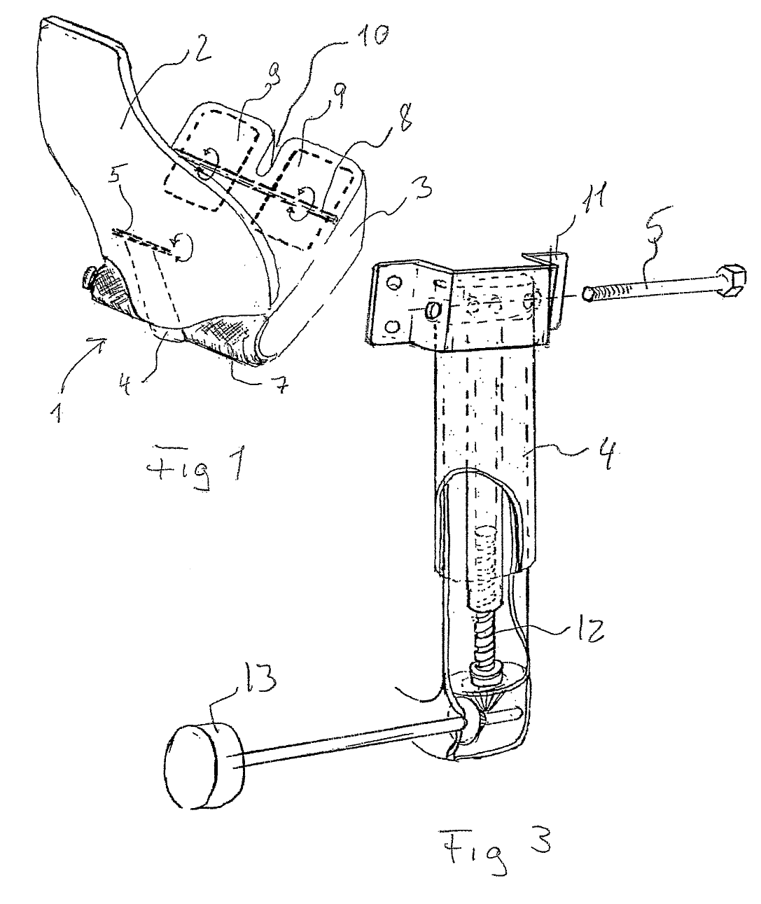

FIG. 1 is a schematic illustration of a first embodiment of the invention, where the seat's back part is attached to a centrally located upward guide with an upper pivoting fitting,

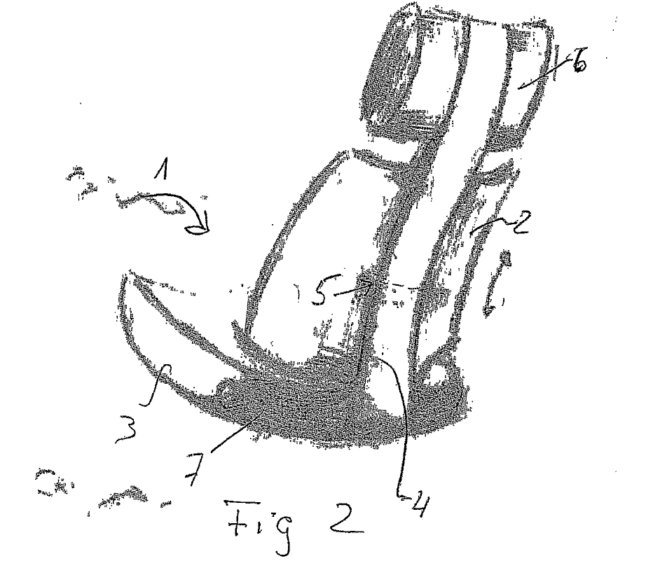

FIG. 2 illustrates a version with a supporting pillar for the seat back with a neck support mounted at the top of the supporting pillar,

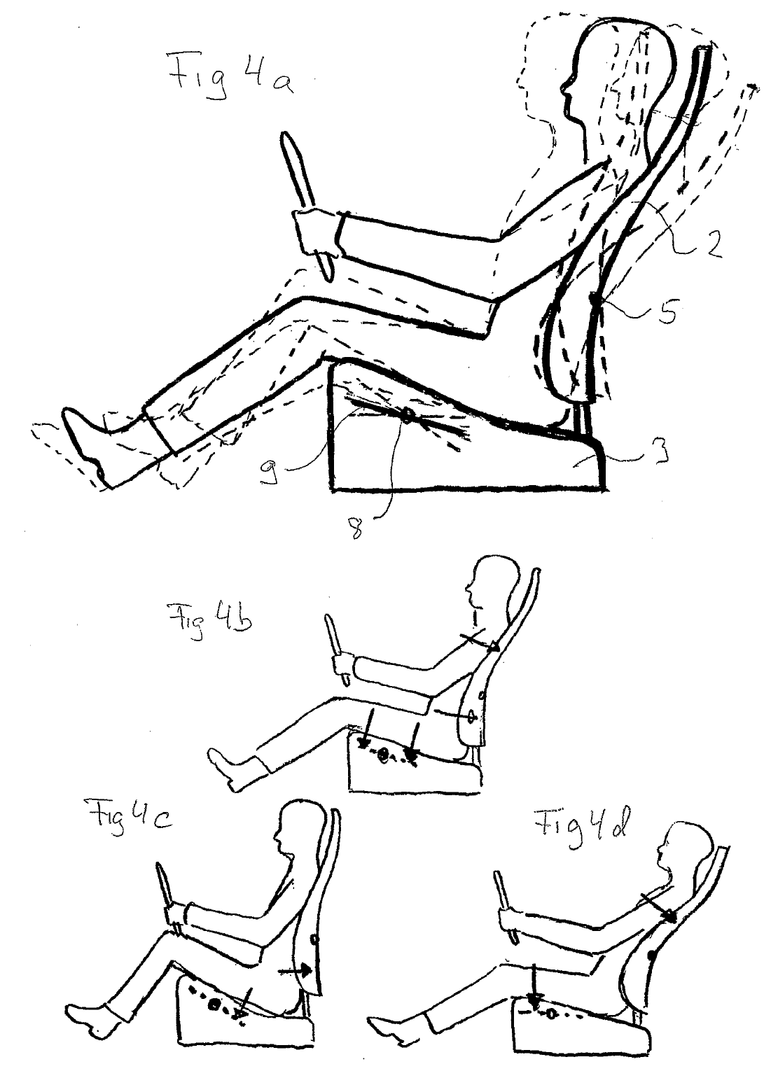

FIG. 3 is a schematic illustration of an example of an adjustment mechanism in the upward guide,

FIGS. 4a-d are views illustrating the working principles for the invention.

We should point out that the embodiments depicted are only schematically illustrated, and the individual details in the design of the construction, hinges, etc. will be able to be implemented by a skilled person.

Thus FIG. 1 illustrates a seat 1 for vehicles, such as for example cars, buses, trains or planes, consisting of a seat back or backrest 2 and a seat part 3. In the rear edge of the seat's base or in the rear edge of the seat part 3 there are provided attachment means for a central pillar or upwardly directed guide 4, which projects upwardly in the rear edge of the seat part and forms a supporting part for the mechanism according to the invention. In the embodiment in FIG. 1, this upwardly directed pillar part ends in the central area of the backrest 2 and is equipped at the end with a fitting for attachment to the backrest 2 and functions together with a horizontal axis of rotation 5. In the illustrated embodiment the pillar 4 is inserted in the seat back, with the result that it is partly covered by a rear piece on the seat back 2. If a user of the seat 1 now sits well back on the seat part 3, his rear portion will press in against the back part's 2 lower portion, pushing it backwards. The set back will then pivot or tilt about the fitting 5 with its hinge, thus causing the upper part of the back 2 to move forwards. As can be seen in the illustration in FIG. 4a, this will be a limited movement. In FIG. 1 the chair back is pulled up, with the result that the upper part of the seat back also forms a neck support (safety) for the user. The upwardly directed guide need not be centred along the backrest's central axis, even though this is the most favourable location and provides the simplest design of the pivoting mechanism for the backrest. Depending on the design of the seat, the upward guide will also be able to be located asymmetrically.

FIG. 1 also illustrates the principle for arranging a tiltable front part in the seat part 3. In the upper part of the seat part 3, but still upholstered, a plate 9 is mounted which can swivel about an axis of rotation 8. When the user of the seat lifts his knees or settles deep into the seat, the plate 9 will move upwards in the front edge and be pushed down in the rear edge, with the result that in such a position the user will also have full support for his thighs. If he stretches out his leg, the plate 13 will tilt down in the front edge, while the rear edge is tilted up. In this way the user will at all times have full support for his legs.

FIG. 1 illustrates such a seat, where the seat 3 has a cut-out 10 and the plate 9 is in two parts, thus enabling the user to receive individual support for both of his legs, with the result that, for example, he can lift one leg while the other is stretched out. In the front or rear edges of the plate a spring or an activatable mechanism (not shown) may be mounted for holding the plate part 9 in a predetermined position. In the version with a divided plate, the seat cover will conceal the plates and the division thereof. The seat part 3 and the plate 9 may naturally also be undivided (not shown).

The tilting mechanism is preferably provided in the front third of the seat.

FIG. 2 illustrates an embodiment where the seat 1 has a central pillar 4, which is mounted behind the actual back part 2. In the same way as in FIG. 1, in the area in the centre of the backrest and in this embodiment also in the middle of the pillar 4, a fitting with a hinge 5 is mounted, thus enabling the seat back to tilt about this point. In this embodiment the pillar 4 is moved right up to the area for support of the neck and head. In this embodiment the neck support 6 is designed as a separate part, which can be adjusted slightly in the height direction. The neck support 6 may either be attached to a mechanism in the pillar so that it is rigidly connected to and follows the backrest's movement, or it may be securely fixed to the pillar. In the latter case the neck support must be of an active type, so as to compensate for any distance to the backrest.

FIG. 3 illustrates a design of the upward guide 4 with the axis of rotation 5 for the backrest. At the top of the upward guide or the pillar are holes for passing through an axis of rotation 5. On the axis of rotation 5 there is also mounted a fitting 11 which is attached to the backrest and is designed so as to permit a limited tilting motion for the backrest. In the upward guide there is provided a spindle mechanism 12 which by means of a control arm with wheels 13 permits a movement of the axis of rotation to the desired height for the user.

FIGS. 4a-d illustrate the working principle for the invention, including the tilting of the seat part.

FIG. 4a illustrates with dotted lines the positions the seat can assume when the user sits in different positions. Even though there is a natural interplay here between the tilting mechanisms in the seat part and back part, it will be possible to achieve individual positions, for example by stretching one's legs.

FIG. 4b illustrates the position in a normal position, while FIGS. 4c and 4d illustrate two extreme positions.

Many modifications of the invention will be possible. The design of the upward guide, fitting, backrests, seat parts etc. will be capable of variation. Similarly, the tilting function for the backrest will be able to be employed regardless of whether the possibility exists for tilting the seat part and vice versa.

It may also be advantageous if the seat's tiltable support bodies are tilted down in the front edge when getting in and/or out of the car. This can be controlled by means of known devices which move the support bodies into the desired position. The choice of such control means is also considered to lie within the scope of the invention.

1. A seat for vehicles, where the backrest is movable about a horizontal transversal axis relative to the seat back plane,
characterised in that the entire backrest is pivotably attached to a horizontal axis mounted on an upwardly directed supporting part, and that one or more support surfaces in the seat part, at least in the front part, may also be pivotably attached in a horizontal axis.

2. A seat according to claim 1,
characterised in that the tiltable back support is continuously so high up that its upper part acts as, or is a holding body for a neck support (safety support surface for the neck).

3. A seat according to claim 1,
characterised in that the upwardly directed supporting part is a pillar, which is mounted preferably in the backrest's central area, projects up from the seat's basic frame, and that the horizontal axis is mounted on the upper region of the pillar.

4. A seat according to claim 1 or 3,
characterised in that the pillar is extended past the horizontal axis and in its upper region forms a support for a neck support, particularly an active neck support with an inflatable or movable cushion.

5. A seat according to claim 1,
characterised in that the horizontal axis can be raised and lowered.

6. A seat according to claim 1,
characterised in that the backrest has less thickness in the areas out towards the seat's lateral edges than in the area of the upwardly directed supporting part.

7. A seat according to claim 1,
characterised in that the supporting part is attached to the base of the seat, and that the seat back and supporting part may be enveloped by a cover part which conceals the attachment and pivoting mechanism.

8. A seat, particularly for vehicles,
characterised in that the seat's front support portions are tiltable about an axis in the front half of the seat, a tiltable support body being mounted in this seat area.

9. A seat according to claim 8,
characterised in that the support body is divided in the longitudinal direction in order to provide support during different angular positions of the thighs, while the seat cover is preferably whole.

10. A seat according to claim 8,
characterised in that the seat's support bodies are tiltable to a predetermined position by means of suitable control means which are activated, for example, by opening the car door, via the gear lever, ignition lock and the like.
